(19) United States
(12) Patent Application Publication
(10) Pub. No.: US 2005/0263375 A1
(43) Pub. Date: Dec. 1, 2005

(54) Slip conveyor

(75) Inventors: Garry Ronald MacKay, Lidcombe (AU); Alfred Alexander Taylor, Lugarno (AU)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: TNA Australia Pty Limited, Lidcombe (AU)

(21) Appl. No.: 11/108,052

(22) Filed: Apr. 14, 2005

(30) Foreign Application Priority Data
May 11, 2004 (AU) 2004902491

(51) Int. Cl. B65G 27/32

(52) U.S. Cl. 198/759; 198/761

(57) ABSTRACT

A slip conveyor (10) having an elongated pan (11) along which articles are conveyed in a predetermined direction. The pan (11) is vertically and horizontally reciprocated by a drive assembly (22). The drive assembly (22) includes a cowl (25) that governs the operation of a motor (23), the control (25) being configured to operate the motor (23) so that the pan (11) does not have a downward acceleration greater than gravity so that product on the pan (11) remains in contact therewith.

### TECHNICAL FIELD

The present invention relates to sip conveyors and more particularly but not exclusively to slip conveyors that transport food products such as snack foods to packaging machines.

### BACKGROUND OF THE INVENTION

Slip conveyors employ a generally horizontally extending elongated pan that is longitudinally and vertically reciprocated to cause product to move along a conveyor surface of the pan in a predetermined direction.

A problem in respect of the abovementioned slip conveyors is that product can be damaged by impact with the pan as it is conveyed therealong.

### OBJECT OF THE INVENTION

It is the object of the present invention to overcome or substantially ameliorate the above disadvantage.

### SUMMARY OF THE INVENTION

There is disclosed herein a slip conveyor including:

a generally horizontally extending elongated conveyor surface along which articles are conveyed in a predetermined direction;

a support for said surface supporting said surface for longitudinal and vertical reciprocation; and

a drive assembly to cause longitudinal and vertical reciprocation of said surface so that the articles are conveyed in said direction, the reciprocation resulting firm longitudinal and vertical acceleration of said surface, said assembly including a motor and a control for said motor, said control being configured to operate said motor so that downward acceleration of said surface is not greater than gravity so that said articles do not have an upward velocity relative to said surface.

Preferably, said support includes a pair of support members, the support members being located at longitudinally spaced locations relative to said surface, each member being pivotally attached to said surface for pivoting movement relative thereto about an upper axis that is generally horizontal and transverse relative to said surface, each member extending downwardly relative to said surface for pivoting attachment to a supporting floor for relative movement with respect thereto about a lower axis that is generally horizontal and generally transverse with respect to said surface.

Preferably, each member angularly reciprocates between a generally upright position and an inclined position, said inclined position being angularly spaced from said upright position generally in a direction opposite said predetermined direction.

Preferably, said inclined position is spaced from said upright position by a predetermined angle of about 20° to 30°.

There is further disclosed herein a method of slip conveying articles, said method including the steps of:

providing a generally horizontally extending elongated conveyor surface along which the articles are to be conveyed in a predetermined direction;

vertically and longitudinally accelerating said surface to cause said articles to move therealong; and wherein

downward acceleration of said surface does not exceed gravity so that said articles do not have an upward velocity relative to said surface.

### BRIEF DESCRIPTION OF THE DRAWINGS

A preferred form of the present invention will now be described by way of example with reference to the accompanying drawings wherein:

FIG. 1 is a schematic side elevation of a slip conveyor;

FIG. 2 is a schematic end elevation of a slip conveyor of FIG. 1.

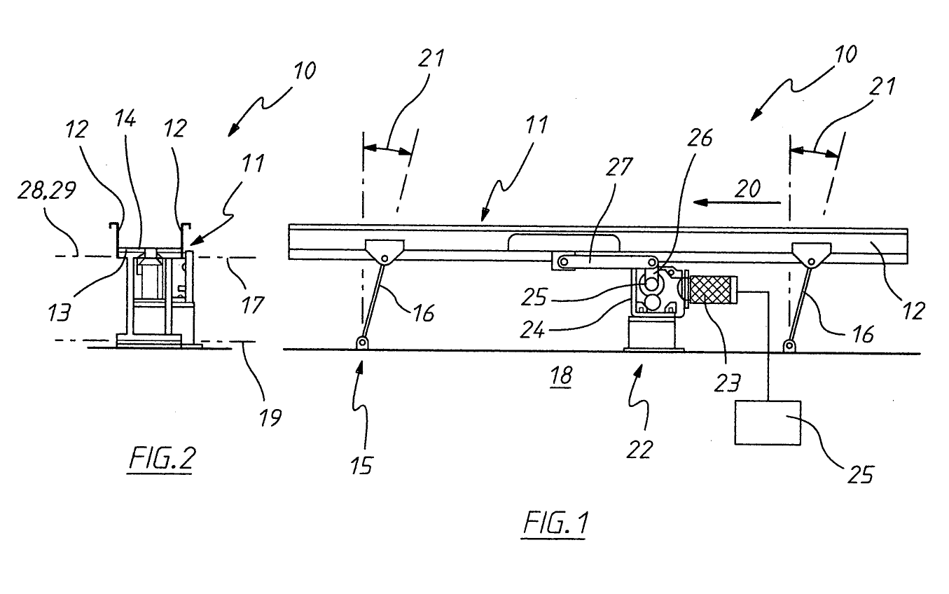

### DETAILED DESCRIPTION OF THE PREFERRED EMBODIMENT

In the accompanying drawings there is schematically depicted a slip conveyor 10. The slip conveyor 10 includes an elongated pan 11 that is generally “U” shaped in transverse cross-section so as to have a pair of longitudinally extending generally parallel transversely spaced side walls 12 joined by a pan floor 13 having an upwardly facing conveyor surface 14 that is elongated and generally horizontally extending and along which the articles to be conveyed are moved.

The pan 11 is supported by a support assembly 15 that includes a pair of support members 16 that are located at longitudinally spaced locations relative to the surface 14. Each member 16 is pivotally attached to the pan 11 for pivoting movement relative thereto about a generally horizontal axis 17 exuding transverse relative to the surface 14.

Bach member 16 extends downwardly relative to the surface 14 to be pivotally attached at its lower end to a floor 18 for pivoting movement about a generally horizontal axis 19 extending generally transverse relative to the surface 14.

Articles located in the pan 11 are conveyed in the direction 20. This movement of the articles is caused by acceleration of the pan 11 both longitudinally and vertically. More particularly the pan 11 is longitudinally and vertically reciprocated by angular reciprocation of the members 16. The members 16 reciprocate angularly between a generally upright position and a position spaced angularly from the upright position in a direction generally opposite the direction 20. That is each member 16 angularly reciprocate through an angle 21. Preferably, the angle 21 is from about 20° to about 30°.

The pan 11 is accelerated both longitudinally and vertically by a drive assembly 22. The drive assembly 22 includes a rotary electric motor 23 that drives a gear box 24. The gear box 24 has an output shaft 25 to which there is attached a “crank” arm 26. The arm 26 is attached to a linkage 27 that in turn is attached to the pan 11. The arm 26 is pivotally attached to the linkage 27 for pivoting movement relative thereto about a generally horizontal axis 28 extending transverse of the surface 14 so as to be generally parallel to the axes 17 and 19. Similarly, the linkage 27 is pivotally attached to the pan 11 for pivoting movement relative thereto about a generally horizontal axis 29 also extending transverse of the surface 14 and therefore generally parallel to the axes 17, 19 and 28.

When a conveying speed for the articles is selected, the motor 23 is operated at a generally constant speed to provide that conveying speed. If a greater conveying speed is required, the motor 23 is operated at a greater generally constant speed. When the motor 23 is operated the arm 26 rotates at a generally constant angular velocity.

The assembly 22 further includes a control 25 that delivers electric power to the motor 23. The control 25 is configured 80 that the motor 23 operates at a constant velocity so that the articles on the suffice 14 do not have a vertical velocity relative to the surface 14 and therefore are retained in contact therewith while moving longitudinally in the direction 20. This has the advantage of reducing impact damage to the articles.

When the motor 23 is operated and the pan 11 moved in the direction 20, the members 16 pivot so that the pan 11 is accelerated upwardly thereby urging the articles into contact with the surf 14 so that they arc conveyed in the direction 20. When the pan 11 is moving in the opposite direction to the direction 20, the pan 11 is accelerated downwardly however, that acceleration is not greater than gravity. As the pan 11 has a downward acceleration, the articles in contact with the surface 14 have a reduced contact pressure with respect thereto. Accordingly, the articles have a resulting overall direction of movement in the direction 20.

1. A slip conveyor including:
a generally horizontally extending elongated conveyor along which articles are conveyed in a predetermined direction;
a support for said surface supporting said surface for longitudinal and vertical reciprocation; and
a drive assembly to cause longitudinal and vertical reciprocation of said surface so that the articles are conveyed in said direction, the reciprocation resulting from longitudinal and vertical acceleration of said surface, said assembly including a motor and a control for said motor, said control being configured to operate said motor so that downward acceleration of said surface is not greater than gravity so that said articles do not have an upward velocity relative to said surface.

2. The conveyor of claim 1, wherein said support includes a pair of support members, the support members being located at longitudinally spaced locations is relative to said surface, each member being pivotally attached to said surface for pivoting movement relative thereto about an upper axis that is generally horizontal and transverse relative to said surface, each member extending downwardly relative to said surface for pivoting attachment to a supporting floor for relative movement with respect thereto about a lower axis that is generally horizontal and generally transverse with respect to said surface.

3. The conveyor of claim 2, wherein each member angularly reciprocates between a generally upright position and an inclined position, said inclined position being angularly spaced from said upright position generally in a direction opposite said predetermined direction.

4. The conveyor of claim 3, wherein said inclined position is spaced from said upright position by a predetermined angle of about 20° to 30°.

5. A method of slip conveying articles, said method including the steps of:
providing a generally horizontally extending elongated conveyor surface along which the articles are to be conveyed in a predetermined direction;
vertically and longitudinally accelerating said surface to cause said articles to move therealong; and wherein
downward acceleration of said surface does not exceed gravity so that said articles do not have an upward velocity relative to said surface.
